(19) United States
(12) Patent Application Publication
(10) Pub. No.: US 2011/0226118 A1
(43) Pub. Date: Sep. 22, 2011

(54) SIGNAL PROCESSING DEVICE AND STRINGED INSTRUMENT

(75) Inventor: Ryuichiro KUROKI, Hamamatsu-Shi (JP)

(73) Assignee: YAMAHA CORPORATION, Hamamatsu-Shi (JP)

(21) Appl. No.: 13/049,752

(22) Filed: Mar. 16, 2011

(30) Foreign Application Priority Data
Mar. 18, 2010 (JP) 2010-063306

(51) Int. Cl. G10H 1/06

(52) U.S. Cl. 84/735

(57) ABSTRACT

A signal processing device is composed of an acquiring unit, a filter unit and a changing unit. The acquiring unit acquires a signal indicating vibration of a string. The filter unit performs convolution operation on the signal acquired by the acquiring unit according to a filter coefficient and outputs a resulting signal. The filter coefficient is set such that the resulting signal has a frequency response containing a plurality of peak waveforms associated with resonance of a body of a stringed instrument within a specific frequency range. The changing unit changes the filter coefficient so as to change a peak value of each of the peak waveforms while maintaining a width of each of the peak waveforms in the frequency response.

### BACKGROUND OF THE INVENTION

1. Technical Field of the Invention

The present invention relates to a technology for imparting a stringed instrument's resonance effect to an audio signal.

2. Description of the Related Art

The volume of sound played with a stringed instrument such as an acoustic guitar is limited. Therefore, during a live performance with the stringed instrument in a large hall, a microphone is used to receive and amplify the played sound to increase the volume of the played sound. In this method, when another instrument is present, the microphone may also pick up sound produced by the other instrument and howling may also occur. Thus, the stringed instrument may use a piezoelectric element for the pickup to convert string vibration into an electrical signal and then to amplify the electrical signal to increase the volume. However, use of the piezoelectric element reduces the influence of resonant sound of a body of the stringed instrument, which is referred to as “body resonance,” although it is possible to obtain electrical signals of string vibrations. Thus, in many cases, a sound heard from the stringed instrument when the piezoelectric element is used for the pickup is different from performance sound directly heard from the stringed instrument.

Therefore, Japanese Patent Application Publication No. 2009-162997 has disclosed a technology in which an electrical signal obtained using a piezoelectric element for the pickup is not only amplified but convolution operation is also performed on the signal using a Finite Impulse Response (FIR) filter to add a resonant sound or the like of the body to the signal.

However, in the technology of Japanese Patent Application Publication No. 2009-162997, the user cannot intentionally emphasize or suppress the components of resonant sound of the body since the characteristics of the FIR filter are determined according to a transfer function having characteristics corresponding to the difference between a signal detected by the microphone and a signal from the piezoelectric element.

In addition, in many cases, the resonant sound of the body has peaks at specific frequencies. Therefore, an equalizer may be used to adjust the level of each frequency. However, this requires the user to perform complex manipulations since the user needs to search for the specific frequencies and to emphasize or suppress the levels of the specific frequencies. Moreover, if sound is emitted after the electrical signal representing the resonant sound of the body is amplified, the body and strings of the stringed instrument may additionally resonate due to the influence of the peak components of the specific frequencies, thereby causing howling.

### SUMMARY OF THE INVENTION

The invention has been made in view of the above circumstances and it is an object of the invention to add resonant sound of the body of a stringed instrument to an electrical signal representing vibration of a string(s) of the stringed instrument while allowing the user to intentionally emphasize or suppress the components of resonant sound of the body of the stringed instrument, to provide simple manipulation for adjusting volume of resonant sound, and to prevent howling due to the resonant sound.

To achieve the above object, the invention provides a signal processing device comprising: an acquiring unit that acquires a signal indicating vibration of a string; a filter unit that performs convolution operation on the signal acquired by the acquiring unit according to a filter coefficient and outputs a resulting signal, wherein the filter coefficient is set such that the resulting signal has a frequency response containing a plurality of peak waveforms associated with resonance of a body of a stringed instrument within a specific frequency range; and a changing unit that changes the filter coefficient so as to change a peak value of each of the peak waveforms while maintaining a width of each of the peak waveforms in the frequency response.

In a preferred embodiment, the filter unit comprises: a first filter in which a filter coefficient thereof is set such that the frequency response of the resulting signal contains the plurality of peak waveforms associated with the resonance of the body of the stringed instrument within the specific frequency range; and a second filter in which another filter coefficient for changing the frequency response is set, and wherein the changing unit changes the filter coefficient set in the second filter.

In another preferred embodiment, the changing unit changes the filter coefficient such that a predetermined relationship between peak values of the peak waveforms in the frequency response is maintained.

In another preferred embodiment, the signal processing device further comprises a manipulation unit including manipulators for receiving a manipulation from a user, wherein the changing unit changes the filter coefficient according to a single manipulation received through one of the manipulators.

In another preferred embodiment, the signal processing device further comprises a storage unit that stores a table recording at least a first filter coefficient and a second filter coefficient, the first filter coefficient corresponding to a frequency response in which a peak value of one of the peak waveforms appears as a first value, the second filter coefficient corresponding to a frequency response in which the peak value of the one of the peak waveforms appears as a second value, wherein the manipulation unit receives a manipulation for specifying a peak value of the peak waveform, and the changing unit calculates a filter coefficient corresponding to the specified peak value through interpolation using the first filter coefficient and the second filter coefficient when the peak value of the peak waveform specified according to the manipulation received by the manipulation unit is neither the first value nor the second value, and changes the filter coefficient set in the filter unit to the calculated filter coefficient.

The invention also provides a stringed instrument comprising: a body; a string; a conversion unit that converts vibration of the string into a signal and outputs the signal; an acquiring unit that acquires the signal from the conversion unit; a filter unit that performs convolution operation on the signal acquired by the acquiring unit according to a filter coefficient and outputs a resulting signal, wherein the filter coefficient is set such that the resulting signal has a frequency response containing a plurality of peak waveforms associated with resonance of the body of the stringed instrument within a specific frequency range; and a changing unit that changes the filter coefficient so as to change a peak value of each of the peak waveforms while maintaining a width of each of the peak waveforms in the frequency response.

According to the invention, it is possible to add resonant sound of the body of a stringed instrument to an electrical signal representing vibration of a string(s) of the stringed instrument while allowing the user to intentionally emphasize or suppress the components of resonant sound of the body of the stringed instrument, to provide simple manipulation for adjusting volume of the resonant sound, and to prevent howling due to the resonant sound.

### BRIEF DESCRIPTION OF THE DRAWINGS

FIG. 1 illustrates an exterior of a guitar according to an embodiment of the invention;

FIG. 2 is a block diagram illustrating the configuration of a signal processing device according to an embodiment of the invention;

FIG. 3 illustrates frequency responses of a filter unit according to an embodiment of the invention; and

FIG. 4 illustrates a setting table according to an embodiment of the invention.

### DETAILED DESCRIPTION OF THE INVENTION

### Embodiments

[Exterior Configuration]

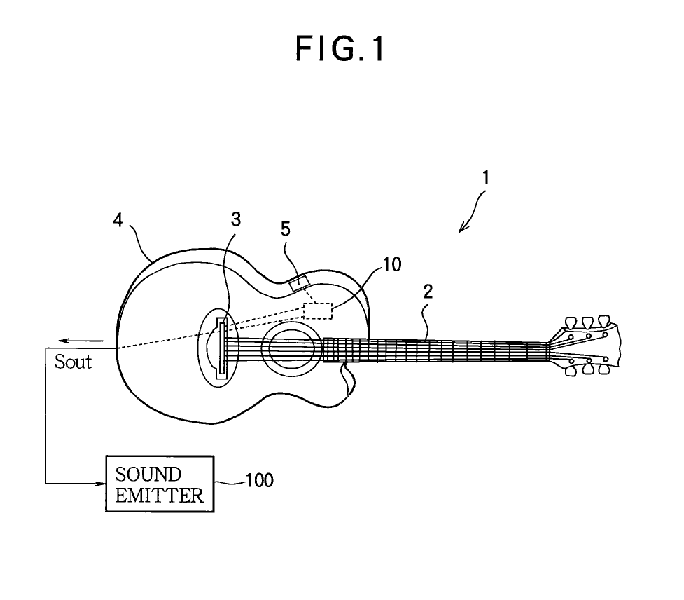

FIG. 1 illustrates an exterior of a guitar 1 according to an embodiment of the invention. The guitar 1 is a stringed instrument constructed by mounting a signal processing device 10 and a manipulation unit 5 to an acoustic guitar including strings 2, a pickup 3, and a body 4. The guitar 1 includes a terminal through which an audio signal Sout output from the signal processing device 10 is provided to an external device. The terminal is connected to a sound emitter 100 including a speaker, an amplifier, and the like through a shielded line or the like. Through this connection, the guitar 1 provides the audio signal Sout to the sound emitter 100 to emit a corresponding sound.

The pickup 3 is a conversion unit that includes a piezoelectric element and converts vibrations of the strings 2 into an electrical signal (hereinafter referred to as an “audio signal Sin”) through the piezoelectric element.

The manipulation unit 5 includes a rotary switch, a manipulation button, and the like and outputs, upon receiving a signal of a manipulation that the user has performed on the manipulation unit 5, information indicating details of the manipulation.

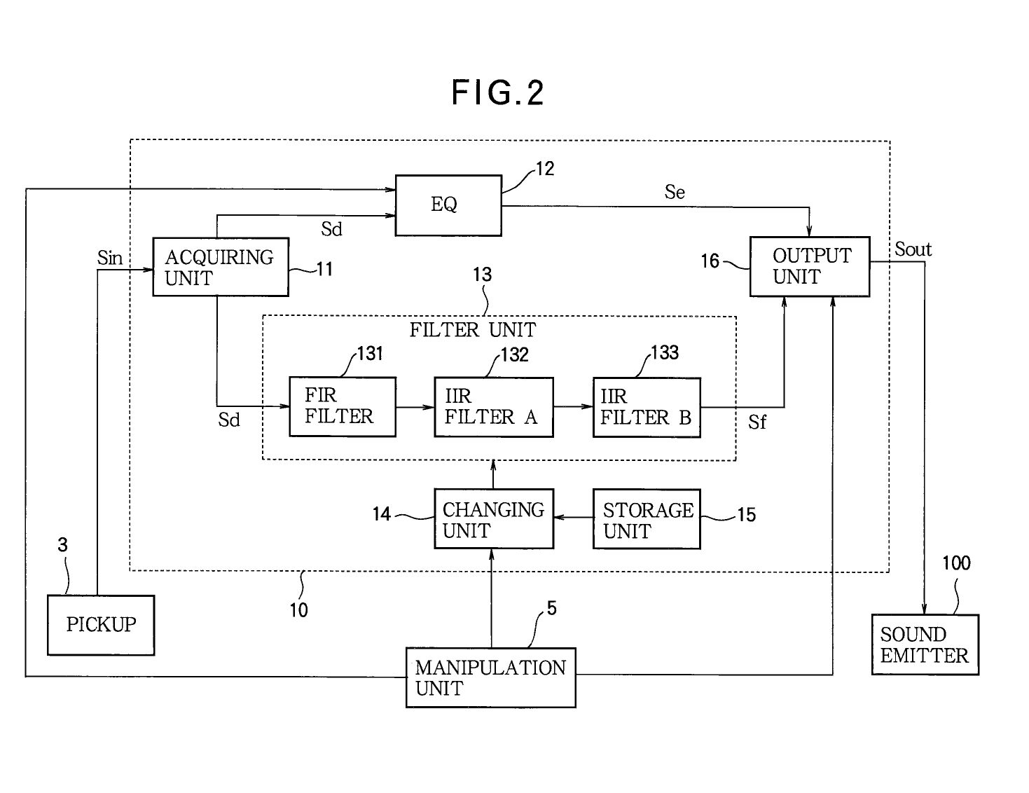

The signal processing device 10 acquires the audio signal Sin output from the pickup and the information output from the manipulation unit 5. A configuration of the signal processing device 10 is described below with reference to FIG. 2.

[Configuration of Signal Processing Device]

FIG. 2 is a block diagram illustrating the configuration of the signal processing device 10 according to an embodiment of the invention. The signal processing device 10 includes an acquiring unit 11, an equalizer (EQ) 12, a filter unit 13, a changing unit 14, a storage unit 15, and an output unit 16.

The acquiring unit 11 acquires an audio signal Sin output from the pickup 3 and converts the audio signal Sin from analog to digital and outputs the resulting audio data Sd to the equalizer 12 and the filter unit 13.

The equalizer 12 performs an equalization process on the audio data Sd according to setting data so as to output audio data Se. The setting data is set based on a manipulation performed on the manipulation unit 5 by the user.

The filter unit 13 includes an FIR filter 131, an Infinite Impulse Response (IRR) filter A 132, and an IIR filter B 133. The filter unit 13 performs convolution processes on the input audio data Sd sequentially using the FIR filter 131, the IIR filter A 132, and the IIR filter B 133 and outputs an audio signal Sf.

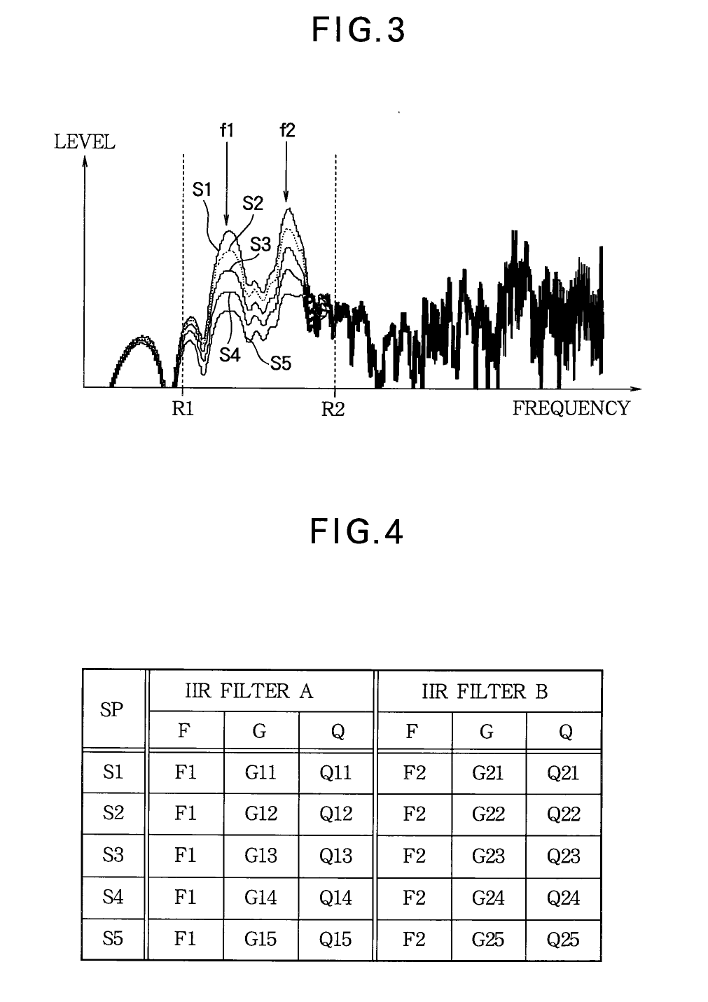

The filter unit 13 is configured so as to selectively obtain one frequency response from among a plurality of frequency responses shown in FIG. 3 using filter coefficients set in the FIR filter 131, the IIR filter A 132, and the IIR filter B 133.

FIG. 3 illustrates frequency responses of the filter unit 13. In FIG. 3, the vertical axis represents frequency and the horizontal axis represents level in spectrums S1, S2, S3, S4, and S5 representing the frequency responses of the filter unit 13. The spectrum S3 represents the frequency response of the FIR filter 131.

The filter coefficients set in the FIR filter 131 are obtained by estimating filter coefficients corresponding to the transfer function of an acoustic path between a pickup and a microphone based on comparison between a signal from the pickup of the guitar and a guitar sound signal including a resonant sound received by the microphone. A detailed description of the method for obtaining the filter coefficients are omitted herein since the methods are described in Japanese Patent Application Publication No. 2009-162997 and corresponding application publications of US2009-173218, EP2077549 and CA2648419. All of the disclosures contained in these publications are incorporated herein by referencing thereto. Although the filter coefficients are described as being fixed in this embodiment, the filter coefficients may also be updated as in Japanese Patent Application Publication No. 2009-162997. Since the filter coefficients obtained in this manner are set in the FIR filter 131, a signal obtained through the FIR filter 131 has the frequency response represented by the spectrum S3. That is, the FIR filter 131 performs convolution operation to reproduce the resonant sound of the body 4 of the guitar 1. Stated otherwise, the FIR filter 131 convolutes the input audio data Sd with the transfer function of the acoustic path between the pickup and the microphone so as to impart the frequency response represented by the spectrum S3 of FIG. 3 to the output audio data Sf.

The frequency response of the output signal in this embodiment has a plurality of characteristic peaks (two peaks f1 and f2 in this example) corresponding to the resonant sound of the body 4. The peaks f1 and f2 appear as the plurality of characteristic peaks in a specific frequency range of low-pitched audio frequencies R1 to R2 (for example, about 50 to 350 Hz). In this example, the peaks f1 and f2 are located at frequencies of about 110 Hz and 200 Hz, respectively.

Unlike the spectrum S3, the spectrums S1, S2, S4, and S5 represent the frequency responses of the filter unit 13 obtained by changing the filter coefficients set in the IIR filter A 132 and the IIR filter B 133. Specifically, the spectrums S1, S2, S4, and S5 are obtained by changing the peak values of the peaks f1 and f2 while maintaining the widths of the peak waveforms of the peaks f1 and f2. Although the widths of the peak waveforms are defined, for example, full widths at half maximum (FWHMs) of the peak waveforms, each of the widths of the peak waveforms may also be defined as the width of a range between frequencies at a level which has a predetermined ratio to the peak value or the width of a range between frequencies at a predetermined level. Hereinafter, such change of the peaks f1 and f2 while maintaining the widths thereof in this manner is simply referred to as “change of the peaks f1 and f2”. Here, the peaks f1 and f2 are changed such that a predetermined relationship between the peak values thereof is maintained. In this example, the peaks f1 and f2 are set to be changed at the same ratio.

The filter unit 13 can suppress howling resulting from the influence of the peaks f1 and f2 of the resonant sound or otherwise emphasize the resonance feeling of the body by additionally performing second convolution operation on a signal obtained through the first convolution operation by the FIR filter 131 using the filter coefficients set in the IIR filter A 132 and the IIR filter B 133 so as to increase or decrease the peak values of the peaks f1 and f2 in the frequency response in the above manner. Here, the filter unit 13 can emphasize the resonance feeling of the body or suppress howling resulting from the influence of the peaks f1 and f2 by changing the peak values of the peaks f1 and f2 rather than changing all levels. When the peaks f1 and f2 are emphasized, it is also possible to emphasize the characteristics of the resonant sound of the body 4 while suppressing howling by appropriately setting the frequency bands of the peaks f1 and f2 that are emphasized.

The IIR filter A 132 and the IIR filter B 133 function as so-called parametric equalizers for emphasizing or suppressing the characteristics of the resonant sound of the body 4 in the audio signal to which the resonant sound of the body 4 has been added through the FIR filter 131. Specifically, the IIR filter A 132 is a filter for changing the peak f1 in the frequency response and the IIR filter B 133 is a filter for changing the peak f2 in the frequency response.

Referring back to FIG. 2, the changing unit 14 changes the filter coefficients set in the IIR filter A 132 and the IIR filter B 133 in the filter unit 13 according to a peak value that the user has specified by manipulating the manipulation unit 5. In this example, the user specifies a peak value by rotating one manipulator (for example, a rotary switch) on the manipulation unit 5. In the example, it is assumed that the peak value specified by the user is the peak value of the peak f1. The user only needs to specify any value used to change the peak value. For example, the user may specify a relative amount (i.e., a percentage) by which the peak value is to be changed.

The changing unit 14 changes the filter coefficients with reference to a setting table stored in the storage unit 15.

FIG. 4 illustrates a setting table according to an embodiment of the invention. At least a first filter coefficient corresponding to a frequency response in which a peak value of a peak waveform appears as a first value and a second filter coefficient corresponding to a frequency response in which the peak value of the peak waveform appears as a second value are designated in the setting table. In this example, filter coefficients that are to be set in the IIR filter A 132 and the IIR filter B 133 in association with frequency responses of spectrums having peaks f1 and f2 whose peak values are designated as shown in FIG. 3 are designated in the setting table. In this example, a frequency F, a gain G, and a Q value are designated as filter coefficients that are to be set in the IIR filter A 132 and the IIR filter B 133.

The filter coefficient “frequency F” is a value indicating the center of a frequency band whose levels are to be increased or decreased. A value “F1” is set as the frequency of the peak f1 in the IIR filter A 132 and “F2” is set as the frequency of the peak f2 in the IIR filter B 133. A value, which is adjusted from the frequency corresponding to the peak value based on the relationship with the gain or Q value, may also be set in the IIR filter A 132.

Filter coefficients G13 and G23 for the gain G are “0 dB”. This allows the frequency response of the filter unit 13 to be the same as the frequency response of the FIR filter 131. Among the filter coefficients for the gain G, filter coefficients G11 and G21 are designated to be, for example, “+6 dB” and G12 and G22 are designated to be, for example, “+3 dB” to increase the peak values of the peaks f1 and f2 by a certain amount so as to emphasize the body resonance, and G14 and G24 are designated to be, for example, “−3 dB” and G15 and G25 are designated to be, for example, “−6 dB” to decrease the peak values of the peaks f1 and f2 by a certain amount. Accordingly, the peak values of the peaks f1 and f2 are changed at the same ratio.

The Q value is a coefficient indicating the bandwidth to be changed and is defined as a bandwidth (FWHM) between frequencies, the levels of which are −3 dB relative to the level of the central frequency F1 and F2. The Q value is also designated as a value according to the bandwidth of the peak f1 and f2. In the case where the FWHMs of the peaks f1 and f2 are held constant, the Q values can be held constant. However, when the peak values of the peaks f1 and f2 have been reduced, a great dip occurs at levels near the peaks. In this case, the Q values are designated to increase as the gain decrease. For example, it can be seen from the spectrum S5 that a small peak is present at the high frequency side of the peak f2 in the frequency response shown in FIG. 3. In this case, to prevent amplification of signals of the small peak, the Q value of the IIR filter B 133 corresponding to the peak f2 is designated in the setting table such that the bandwidth decreases as the peak value is increased. In this manner, the guitar 1 can prevent the occurrence of a great dip, thereby suppressing changes in the sound quality of the audio signal Sout output from the guitar 1.

The above specific values of the central frequency F, the gain G, and the Q value are exemplary and may be set appropriately depending on instrument or depending on the usage purpose or the like of the instrument.

Referring back to FIG. 2, the changing unit 14 changes the filter coefficients set in the IIR filter A 132 and the IIR filter B 133 with reference to the setting table described above. Here, when a spectrum corresponding to the peak value specified by the user is present in the correspondence relationships of the setting table, the changing unit 14 changes the filter coefficients set in the IIR filter A 132 and the IIR filter B 133 to filter coefficients corresponding to the spectrum in the setting table.

The changing unit 14 changes the filter coefficients set in the IIR filter A 132 and the IIR filter B 133 in this manner to change the frequency responses of the filter unit 13 to the frequency responses of the spectrums shown in FIG. 3.

On the other hand, when a spectrum corresponding to the peak value specified by the user is not present in the correspondence relationships of the setting table, the changing unit 14 selects a plurality of spectrums having peak values close to the specified peak value. The changing unit 14 then interpolates parameters corresponding to the plurality of spectrums and uses filter coefficients calculated from the interpolated parameters. This interpolation may be performed by averaging values of two points or using an approximate equation connecting a plurality of points, and may also be performed using any known method.

The changing unit 14 changes the filter coefficients set in the IIR filter A 132 and the IIR filter B 133 to the calculated filter coefficients.

The storage unit 15 is a storage device such as a nonvolatile memory and stores the setting table. The setting table may be allowed to be rewritten by the user.

The output unit 16 acquires the audio data Se and the audio data Sf, converts each of the audio data Se and the audio data Sf from digital to analog, amplifies the two analog audio signals by respective amplification factors (i.e., gains) set for the audio data Se and the audio data Sf, adds the amplified audio signals, and then outputs the resulting signal as an audio signal Sout to the terminal of the guitar 1. Thus, the output unit 16 provides the audio signal Sout to the sound emitter 100 connected to the terminal.

The amplification factors are set as the user specifies by manipulating the manipulation unit 5. Here, when one of the audio data Se and the audio data Sf is set to be excluded from the audio signal Sout, the output unit 16 may set the amplification factor of the audio signal produced through conversion of the audio data to “0”. In addition, components provided in a path for performing processes on the audio data may be set to be disabled.

The above is a description of the configuration of the signal processing device 10.

The guitar 1 of the embodiment of the invention can output the audio signal Sout after adding the resonant sound of the body 4 to the audio signal Sout by performing convolution operation on the audio signal Sin output from the pickup 3 through the filter unit 13 in the above manner. When the audio signal Sout is output from the sound emitter 100, howling may occur due to the influence of the peaks f1 and f2. In this case, the user can manipulate the manipulation unit 5 to reduce the peak values of the peaks f1 and f2 to suppress howling. Here, the changing unit 14 changes filter coefficients set in the filter unit 13 so as to have a frequency response in which levels at frequencies other than the peaks f1 and f2 are not significantly reduced. Accordingly, the guitar 1 can provide the sound emitter 100 with an audio signal Sout in which howling can be reduced without significantly changing the impression of the resonant sound of the body 4. Conversely, the guitar 1 can also increase the peak values of the peaks f1 and f2 to emphasize the resonant sound of the body 4.

<Modifications>

Although the embodiment of the invention has been described above, the invention can provide various other modifications as described below.

[Modification 1]

Although, in the above embodiment, the frequency response of the filter unit 13 is changed such that the peak values of the peaks f1 and f2 are changed in association with each other so as to maintain a predetermined relationship between the peak values of the peaks f1 and f2, the peak values of the peaks f1 and f2 need not be changed in association with each other.

In this case, the storage unit 15 stores a setting table A in which correspondence relationships between the peak value of the peak f1 and filter coefficients to be set in the IIR filter A 132 are designated and a setting table B in which correspondence relationships between the peak value of the peak f2 and filter coefficients to be set in the IIR filter B 133 are designated. When the user specifies the peak value of the peak f1 and the peak f2 by manipulating the manipulation unit 5, the changing unit 14 changes filter coefficients set in the IIR filter A 132 with reference to the setting table A and changes filter coefficients set in the IIR filter B 133 with reference to the setting table B.

In this manner, the guitar 1 may provide the sound emitter 100 with an audio signal Sout which has significantly changed the impression of the resonant sound of the body 4.

[Modification 2]

Although the filter unit 13 includes the FIR filter 131, the IIR filter A 132, and the IIR filter B 133 that are connected in series in the above embodiment, the invention is not limited to this configuration. For example, the filter unit 13 may include a single filter and may also include a large number of filters. That is, the signal processing device 10 according to the invention may include any filter configuration which has a frequency response in which a plurality of peak waveforms corresponding to the resonance of the body 4 appears within a specific frequency range as shown in FIG. 3 and which is constructed such that it is possible to change the peak values of the peak waveforms such that the widths of the peak waveforms are maintained by changing filter coefficients of the filter.

[Modification 3]

Although the storage unit 15 stores the setting table in which the correspondence relationships between the peak values of the peak waveforms and the filter coefficients are designated in the above embodiment, the storage unit 15 may also store the correspondence relationships between the peak values and the filter coefficients as arithmetic expressions. In this case, the changing unit 14 may calculate filter coefficients corresponding to a peak value specified by the user using an arithmetic expression and may then change the filter coefficients set in the filter unit 13 to the calculated filter coefficients. In this modification, it is not necessary to perform the interpolation process described in the above embodiment.

[Modification 4]

Although the signal processing device 10 is a part of the guitar 1 in the above embodiment, the signal processing device 10 need not be a part of the guitar 1. In this case, the signal processing device 10 may include an input terminal for acquiring a signal indicating vibration of the strings of the guitar and a component corresponding to the manipulation unit 5. The storage unit 15 may also store filter coefficients for the FIR filter 131 to achieve frequency responses for reproducing resonant sounds of bodies of various models of guitars and setting tables corresponding respectively to the different guitars. In this case, the changing unit 14 may identify the model of a guitar that outputs an audio signal Sin acquired by the acquiring unit 11 and may then set corresponding filter coefficients in the filter unit 13. Here, the changing unit 14 may identify a model, which the user has specified by manipulating the manipulation unit 5, as the model of the guitar.

This allows the user to use the signal processing device 10 with various models of guitars by connecting the signal processing device 10 to various guitars.

[Modification 5]

Although the guitar 1 has been described as an example of a stringed instrument in the above embodiment, the stringed instrument need not be a plucking type of stringed instrument such as the guitar. The stringed instrument of the invention may be any type of stringed instrument, for example, a bowed instrument such as a violin and a keyboard instrument such as a piano, which uses a string as a sound source and in which a casing such as a body of the instrument resonates due to string vibration. The stringed instrument may include a conversion unit that converts string vibration into an electrical signal.

[Modification 6]

In the above embodiment, the changing unit 14 may also analyze the audio data Sd, determine that howling has occurred when the levels of the frequencies of the peaks f1 and f2 exceed a predetermined value, and automatically change the filter coefficients of the filter unit 13 to reduce the peak values of the peaks f1 and f2 such that the levels of the frequencies of the peaks f1 and f2 fall equal to or less than the predetermined value.

What is claimed is:

1. A signal processing device comprising:
an acquiring unit that acquires a signal indicating vibration of a string;
a filter unit that performs convolution operation on the signal acquired by the acquiring unit according to a filter coefficient and outputs a resulting signal, wherein the filter coefficient is set such that the resulting signal has a frequency response containing a plurality of peak waveforms associated with resonance of a body of a stringed instrument within a specific frequency range; and
a changing unit that changes the filter coefficient so as to change a peak value of each of the peak waveforms while maintaining a width of each of the peak waveforms in the frequency response.

2. The signal processing device according to claim 1, wherein the filter unit comprises:
a first filter in which a filter coefficient thereof is set such that the frequency response of the resulting signal contains the plurality of peak waveforms associated with the resonance of the body of the stringed instrument within the specific frequency range; and
a second filter in which another filter coefficient for changing the frequency response is set, and wherein
the changing unit changes the filter coefficient set in the second filter.

3. The signal processing device according to claim 1, wherein the changing unit changes the filter coefficient such that a predetermined relationship between the peak values of the plurality of the peak waveforms in the frequency response is maintained.

4. The signal processing device according to claim 1, further comprising a manipulation unit including manipulators for receiving a manipulation from a user,
wherein the changing unit changes the filter coefficient according to a single manipulation received through one of the manipulators.

5. The signal processing device according to claim 4, further comprising a storage unit that stores a table recording at least a first filter coefficient and a second filter coefficient, the first filter coefficient corresponding to a frequency response in which a peak value of one of the peak waveforms appears as a first value, the second filter coefficient corresponding to a frequency response in which the peak value of the one of the peak waveforms appears as a second value,
wherein the manipulation unit receives a manipulation for specifying a peak value of the peak waveform, and
the changing unit calculates a filter coefficient corresponding to the specified peak value through interpolation using the first filter coefficient and the second filter coefficient when the peak value of the peak waveform specified according to the manipulation received by the manipulation unit is neither the first value nor the second value, and changes the filter coefficient set in the filter unit to the calculated filter coefficient.

6. A stringed instrument comprising:
a body;
a string;
a conversion unit that converts vibration of the string into a signal and outputs the signal;
an acquiring unit that acquires the signal from the conversion unit;
a filter unit that performs convolution operation on the signal acquired by the acquiring unit according to a filter coefficient and outputs a resulting signal, wherein the filter coefficient is set such that the resulting signal has a frequency response containing a plurality of peak waveforms associated with resonance of the body of the stringed instrument within a specific frequency range; and
a changing unit that changes the filter coefficient so as to change a peak value of each of the peak waveforms while maintaining a width of each of the peak waveforms in the frequency response.
